(19) United States
(12) Patent Application Publication
(10) Pub. No.: US 2017/0061460 A1
(43) Pub. Date: Mar. 2, 2017

(54) RECOMMENDER SYSTEM AND OPERATION METHOD THEREOF

(71) Applicant: BRIDGE LAB CO., LTD., Seoul (KR)

(72) Inventor: O Cheol KWON, Incheon (KR)

(73) Assignee: BRIDGE LAB CO., LTD., Seoul (KR)

(21) Appl. No.: 15/120,855

(22) PCT Filed: Oct. 27, 2014
(86) PCT No.: PCT/KR2014/010096

§ 371 Date: Aug. 23, 2016

(30) Foreign Application Priority Data
Feb. 25, 2014 (KR) 10-2014-0021722

(51) Int. Cl. G06Q 30/02; G06Q 30/06

(52) U.S. Cl. CPC G06Q 30/0214; G06Q 30/0631

(57) ABSTRACT

Disclosed are a recommender system and an operation method thereof, the operation method comprising the steps of: reading an identification code included in access information provided by a recommender when a recommendee accesses a recommendation site using the access information; collecting activity information on a situation in which the recommendee acts in the recommendation site; and matching the identification code with the activity information and storing the matched code and information in a database.

### TECHNICAL FIELD

At least one example embodiment relates to a recommender system and an operation method thereof, and more particularly, to a recommender system using access information provided from a recommender to a recommendee and an operation method thereof.

### RELATED ART

An advertising providing service according to the related art provides an advertising service using a banner or a pop-up window at mass media, such as a television (TV), a radio, a newspaper, etc., and an Internet website having a relatively user access frequency.

However, with the distribution of smartphones and an increase in the use of the Internet, a number of advertising providing services using mass media is on gradual decrease and cannot attract a variety of advertisings.

Also, an advertising service using a banner or a pop-up window at an Internet website having a relatively high user access frequency may attract many customers through advertising browsing and consulting. However, despite of such advantages, the advertising service generally depends on a method of informing a plurality of unspecific customers without targeting and thus, the quality of advertising may be degraded and it may be difficult to attract real customers.

### DETAILED DESCRIPTION

### Subject

At least one example embodiment provides a recommender system that may attract a reliable true customer based on access information provided from a recommender to a recommendee, and an operation method thereof.

### Solution

An operation method of a recommender system according to at least one example embodiment includes reading an identification code included in access information provided from a recommender, in response to a recommendee accessing a recommendation site based on the provided access information; collecting activity information about a situation in which the recommendee acts at the recommendation site; and matching the identification code and the activity information and storing the matched identification code and activity information in a database.

The identification code may be information that one-to-one matches with the recommender to identify the recommender. The activity information may include situations in which the recommendee accesses a website operated by an advertiser and acts at the website, and may include at least one of personal information, visit frequency information, purchase frequency information, purchase amount information, posting creation information, comment creation information, event participation information, posting sharing information, member join information, social networking service (SNS) friend add information, and application download information.

Depending on example embodiments, the recommender system operation method may further include creating a plurality of identification codes for identifying a plurality of recommenders, respectively; creating a plurality of pieces of access information that include the plurality of identification codes, respectively; and providing the plurality of pieces of access information to the plurality of recommenders, respectively.

Also, the recommender system operation method may further include statistically processing information stored in the database for each identification code; and providing a reward to the recommender based on the statistical processing result.

A recommender system according to at least one example embodiment includes a processor configured to read an identification code included in access information provided from a recommender, in response to a recommendee accessing a recommendation site based on the provided access information; a collector configured to collect activity information about a situation in which the recommendee acts at the recommendation site; and a storage configured to match the identification code and the activity information, and to store the matched identification code and activity information in a database.

Depending on example embodiments, the recommender system may further include an identification code creator configured to create a plurality of identification codes for identifying a plurality of recommenders, respectively; an access information creator configured to create a plurality of pieces of access information that include the plurality of identification codes, respectively; and an access information provider configured to provide the plurality of pieces of access information to the plurality of recommenders, respectively.

Also, the recommender system may further include a statistical operator configured to statistically process information stored in the database for each identification code; and a reward provider configured to provide a reward to the recommender based on the statistical processing result.

### Effects

According to at least some example embodiments, there may be provided a recommender system that may attract a reliable true customer based on access information provided from a recommender to a recommendee, and an operation method thereof.

### BRIEF DESCRIPTION OF DRAWINGS

FIG. 1 is a diagram illustrating a recommender system according to at least one example embodiment.

FIG. 2 is a flowchart illustrating an operation method of a recommender system according to at least one example embodiment.

FIG. 3 illustrates an example of a screen used for a recommendee to access a recommender system according to at least one example embodiment.

FIG. 4 illustrates an example of a screen for creating an identification code and access information according to at least one example embodiment.

FIG. 5 illustrates an example of a screen associated with details for performing statistical processing for each identification code and providing a recommendation to a recommender according to at least one example embodiment.

FIG. 6 is a block diagram illustrating a recommender system according to at least one example embodiment.

### MODE TO CARRY OUT THE INVENTION

Hereinafter, example embodiments will be described with reference to the accompanying drawings and the contents illustrated therein, however, the present disclosure is not limited thereto or restricted thereby.

Meanwhile, when it is determined that the detailed description related to a related known function or configuration they may make the purpose of the example embodiments unnecessarily ambiguous in describing the example embodiments, the detailed description will be omitted here. Also, terminologies used herein are defined to appropriately describe the example embodiments and thus, may be changed depending on a user, the intent of an operator, a custom, and the like. Accordingly, the terminologies must be defined based on the following overall description of this specification.

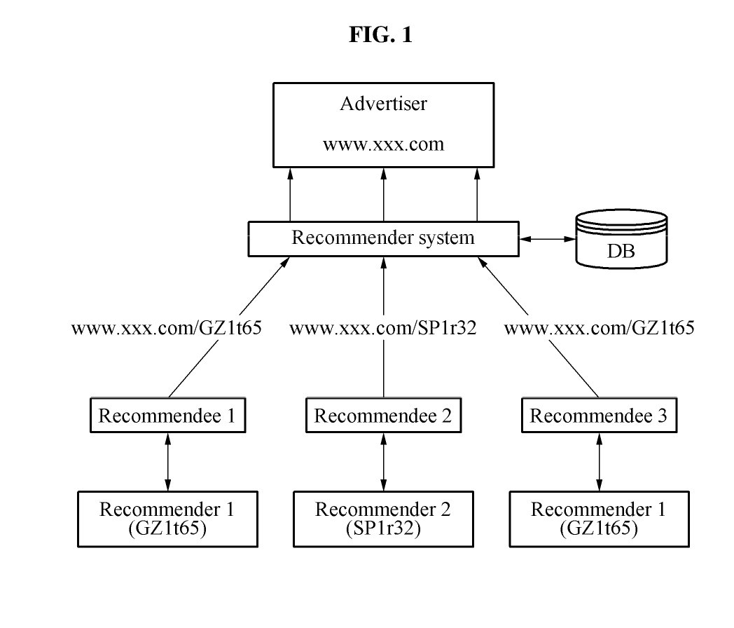

FIG. 1 is a diagram illustrating a recommender system according to at least one example embodiment.

Referring to FIG. 1, the recommender system may collect information about a user that accesses a website or a mobile site operated by an advertiser, and may store the collected information in a database. The recommender system may provide the information stored in the database to the advertiser. Accordingly, the advertiser may perform promotion activities and the like based on information about users that access a site operated by the advertiser.

The recommender system according to at least one example embodiment may collect information about a user (hereinafter, a recommendee) having received a recommendation on a website operated by an advertiser from a recommender.

The recommender may provide access information about a recommendation site to the recommendee. The recommender may be, for example, a supporters recruited to promote the website of the advertiser, a previous customer of a service provided from the advertiser, and the like.

Depending on example embodiments, the recommender may provide access information to the recommendee using a near field communication (NFC) tag that includes access information about the recommendation site. For example, the advertiser or the recommender system may provide, to the recommendee, a device, for example, a membership card, a supporters card, a promotion bracelet, etc., embedded with the NFC tag that includes access information about the recommendation site. Accordingly, the recommender may provide the NFC tag to the recommendee, and the recommendee may access the website of the advertiser through NFC tagging using a smartphone of the recommendee, etc.

Here, the access information provided from the recommender to the recommendee may include an identification code used to identify the recommender. For example, when providing access information to the recommender, the advertiser or the recommender system may create access information in which the identification code capable of identifying the recommender is inserted, and may provide the created access information to the recommender.

According to at least one example embodiment, the recommender system may set an identification code, such as GZ1t65 for recommender 1, SP1r32 for recommender 2, etc. A type of the identification code is not limited to the example of FIG. 1, and any type of codes capable of identifying the recommender may be applicable.

Also, the recommender system may create the access information that includes the identification code in a form in which the identification code and a uniform resource locator (URL) address of the recommendation site are combined. For example, if the URL address of the recommendation site operated by the advertiser is www.xxx.com, the recommender system may create access information to be provided to the recommender 1 in a form of “www.xxx.com/GZ1t65” in which www.xxx.com and GZ1t65 corresponding to the identification code of the recommender 1 are combined, and may provide the created access information. Likewise, the recommender system may create access information to be provided to the recommender 2 in a form of “www.xxx.com/SP1r32,” and may provide the created access information.

The recommendee may access the website of the advertiser based on the access information provided from the recommender. Here, the recommender system may detect the access of the recommendee to the website. Also, the recommender system may read the identification code from the access information used by the recommendee to verify from which recommender the recommendee has received a recommendation on the website.

Also, the recommender system may collect activity information, for example, a name, an email, a telephone number, etc., used by the recommendee while using the recommender system.

Once such activity information is collected and the recommender is identified based on the read identification code, the recommender system may match the read identification code and the activity information, and may store the matched identification code and activity information in the database to track activity details of the recommender. Also, the recommender system may provide information stored in the database to the advertiser.

The advertiser may utilize the provided information to perform promotions, consultations, etc., associated with products, services, etc., of the advertiser with respect to the recommendee. Here, a probability that the recommendee has received the recommendation on the website of the advertiser from the recommender due to relatively high interest or necessity on products, services, etc., of the advertiser is relatively high. Accordingly, the advertiser may be provided from the recommender system with information about a potential customer having a relatively high purchase/use probability regarding products/services, etc., of the advertiser.

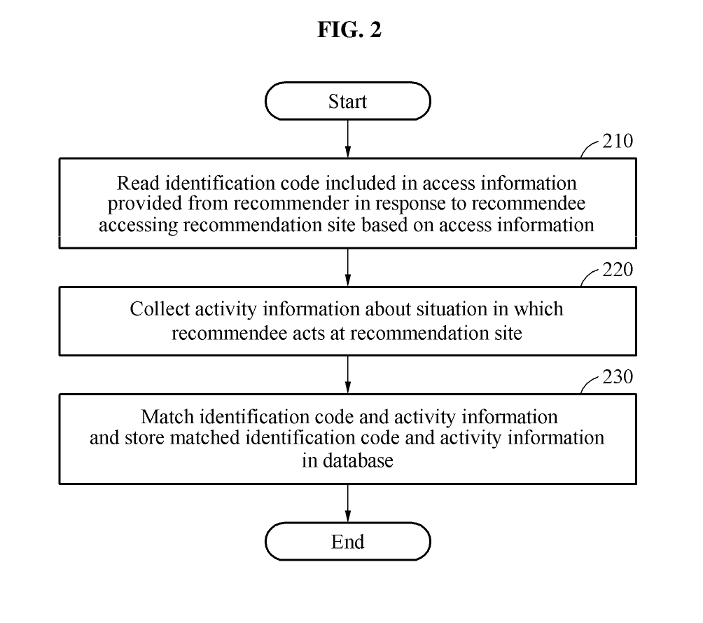

Hereinafter, an operation method of the recommender system according to at least one example embodiment will be described with reference to FIG. 2.

FIG. 2 is a flowchart illustrating an operation method of a recommender system according to at least one example embodiment.

Referring to FIG. 2, in operation 210, in response to a recommendee accessing a recommendation site based on access information provided from a recommender, the recommender system operation method reads an identification code included in the access information.

Once the identification code is read, the recommender system operation method collects activity information about a situation in which the recommendee acts at the recommendation site in operation 220.

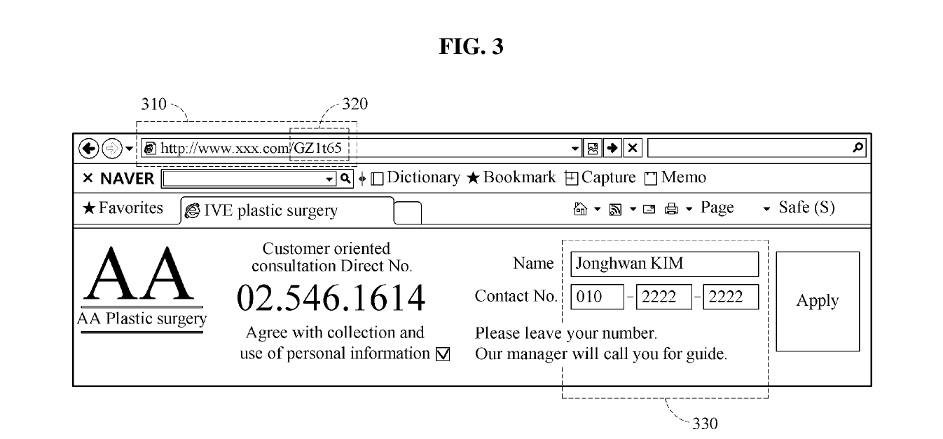

Hereinafter, an operation of reading an identification code included in access information and an operation of receiving activity information about a recommendee in the recommender system operation method according to at least one example embodiment will be described with reference to FIG. 3.

FIG. 3 illustrates an example of a screen used for a recommendee to access a recommender system according to at least one example embodiment.

The screen used for the recommendee to access the recommender system may be a display mounted on a mobile communication terminal or a display mounted on a personal computer.

The screen used for the recommendee to access the computer system may be configured as a touch screen in which a display and a touch pad are provided in a mutual layer structure.

Referring to FIG. 3, in operation 210, in response to a recommendee accessing a recommendation site based on access information 310 provided from a recommender, the recommender system operation method may read an identification code 320 included in the access information 310. The access information 310 provided from the recommender to the recommendee is information that is created by the recommender system and provided from the recommender system to the recommender. Thus, the recommender system may read the identification code 320 based on a preset access information creation logic.

The identification code 320 may be information that one-to-one matches with the recommender to identify the recommender.

The recommendation site may be a website provided from an advertiser or the recommender system.

In operation 220, the recommender system operation method may collect activity information 330 about a situation in which the recommendee acts at the recommendation site.

The activity information 330 refers to some series of situations in which the recommendee accesses a website operated by the advertiser and acts at the website, and may include at least one of personal information, visit frequency information, purchase frequency information, purchase amount information, posting creation information, comment creation information, event participation information, posting sharing information, member join information, social networking service (SNS) friend add information, and application download information.

The personal information may include at least one of contact information, address information, name information, and email information of the recommendee, and the visit frequency information may be information about a number of times that the recommendee has accessed the website of the advertiser. The purchase frequency information and the purchase amount information may be information about a number of purchases and purchase amounts associated with a product/service provided from the advertiser, respectively.

The posting creation information and the comment creation information may be information about a posting and a comment created by the recommendee to inform one of another recommendee and the advertiser, and the event participation information may be participation information about one of a product/service, promotion, and consultation provided from the advertiser. The posting sharing information may be information regarding sharing a posting included in a linked page with the website of the advertiser or another website, for example, an SNS, a blog, other webpages, etc.

The membership join information may be one of an identification number (ID) of the recommendee, a password of the recommendee, identification information of the recommender, and recommendation date information. The SNS friend add information may be friend add information used to build personal connections with the recommendee through a community website, such as Twitter, Myspace, Facebook, Cyworld, and Me2day.

The application download information may be one of information about a number of times that an application provided paid or free is downloaded, information about a date on which the application is downloaded, and version information of the application. The application may be an application program created to execute one of the website of the advertiser and the recommender system in a mobile communication environment.

Referring again to FIG. 2, once the activity information is received, the recommender system operation method matches the identification code and the activity information, and stores the matched identification code and activity information in a database in operation 230.

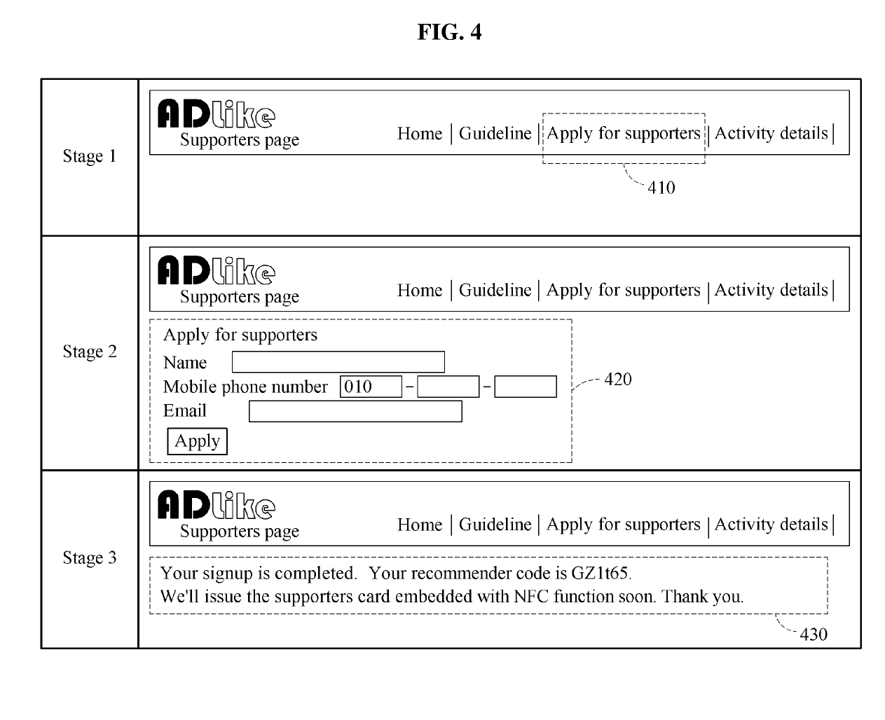

Depending on example embodiments, the recommender system operation method may further include an operation of creating a plurality of identification codes for identifying a plurality of recommenders, respectively, an operation of creating a plurality of pieces of access information that include the plurality of identification codes, respectively, and an operation of providing the plurality of pieces of access information to the plurality of recommenders, respectively. The added operations according to the example embodiments will be described with reference to FIG. 4.

FIG. 4 illustrates an example of a screen for creating an identification code and access information according to at least one example embodiment.

Referring to FIG. 4, the recommender system operation method according to at least one example embodiment may include an operation of setting, by a recommendee, a supporters application menu 410 through a recommendation site provided from an advertiser or a recommender system and an operation of inputting, by the recommendee, supports activity information 420 associated with a supporters application. The “supporters” used herein may be a single form of a recommender of FIG. 1, and the recommender may be recruited as the supporters to recommend a website operated by the advertiser or a product/service provided from the advertiser.

Supporters activity information may include some series of activity situations of the recommender performed through access to the website of the advertiser, and may include at least one of personal information, visit frequency information, purchase frequency information, purchase amount information, posting creation information, comment creation information, event participation information, posting sharing information, member join information, SNS friend add information, application download information, identification information of the recommendee, and recommendation date information of the recommendee.

Once the supporters activity information 420 is input, the operation of creating and providing access information in the recommender system operation method may include an operation of creating an identification code of the recommendee, an operation of creating access information in which the created identification code of the recommendee and a URL address of the recommendation site are combined, and an operation of providing the combined access information to the recommender or issuing a supporters card embedded with an NFC function to provide the access information to the recommender.

Referring again to FIG. 2, depending on example embodiments, the recommender system operation method may further include an operation of statistically processing information stored in the database for each identification code, and an operation of providing a reward to the recommender based on the statistical processing result.

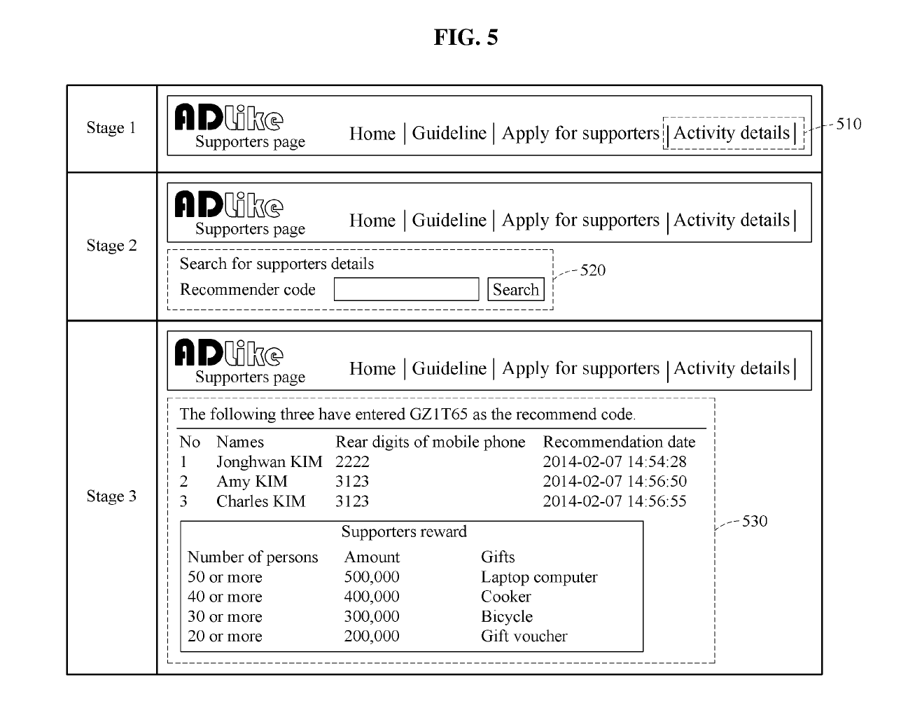

Hereinafter, a process of statistically processing information stored in a database for each identification code and providing a reward to the recommender in the recommender system operation method according to at least one example embodiment will be described with reference to FIG. 5.

FIG. 5 illustrates an example of a screen associated with details for performing statistical processing for each identification code and providing a recommendation to a recommender according to at least one example embodiment.

Referring to FIG. 5, the process of statistically processing information for each identification code and providing a reward to the recommender in the recommender system operation method may include an operation of setting, by a recommendee, an activity details menu 510 through a recommendation site provided from an advertiser or a recommender system and an operation of inputting identification code information 520 of the recommender to search for supporters details.

Once the identification code information 520 is input, the recommender system operation method may include an operation of displaying and thereby providing statistical details information and reward details information 530 on the screen.

As illustrated in FIG. 5, the recommender system operation method may perform statistical processing based on a recommendation date and a number of recommendees for each identification code of the recommender, and may differentially provide the reward based on the recommendation date and the number of recommendees.

Also, the recommender system operation method may provide the reward that includes one of a service, a reward amount, and a physical reward provided from the advertiser or the recommender system.

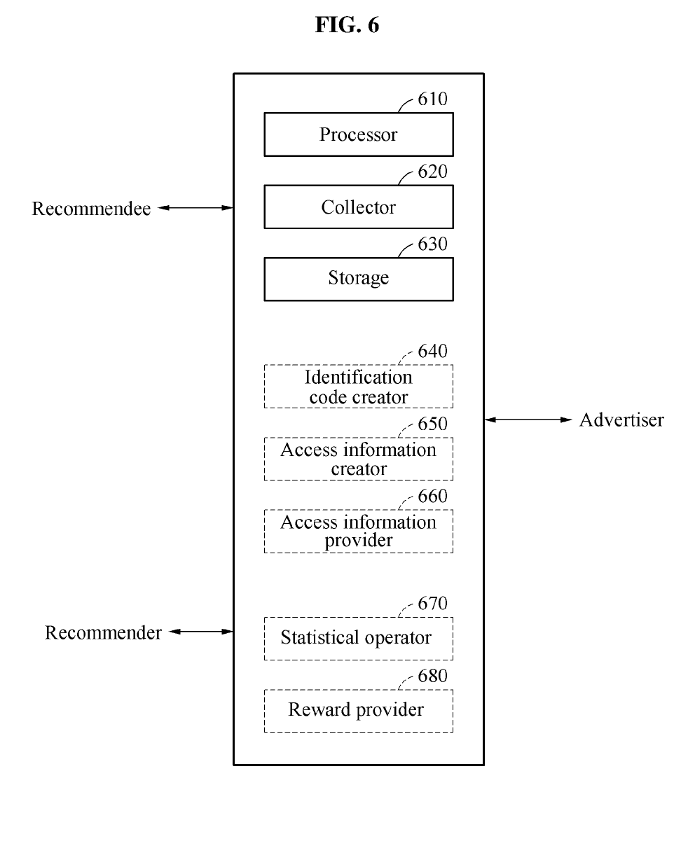

FIG. 6 is a block diagram illustrating a recommender system according to at least one example embodiment. Referring to FIG. 6, the recommender system includes a processor 610, a collector 620, and a storage 630.

In response to a recommendee accessing a recommendation site based on access information provided from a recommender, the processor 610 reads an identification code included in the access information.

Also, the collector 620 collects activity information about a situation in which the recommendee acts at the recommendation site, and the storage 630 matches the identification code and the activity information and stores the matched identification code and activity information in a database.

Depending on example embodiments, the recommender system may further include an identification code creator 640, an access information creator 650, an access information provider 650, a statistical operator 670, and a reward provider 680.

The identification code creator 640 may create a plurality of identification codes for identifying a plurality of recommenders, respectively. The access information creator 650 may create a plurality of pieces of access information that include the plurality of identification codes, respectively. The access information provider 660 may provide the plurality of pieces of access information to the plurality of recommenders, respectively.

Also, the statistical operator 670 may statistically process information stored in the database for each identification code, and the reward provider 680 may provide a reward to the recommender based on the statistical processing result.

The methods according to the example embodiments may be recorded in non-transitory computer-readable media in a form of program instructions executable through a variety of computer devices. The media may also include, alone or in combination with the program instructions, data files, data structures, and the like. The program instructions stored in the media and may be those specially designed and constructed for the example embodiments, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially designed to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments or vice versa.

While the foregoing example embodiments have been described and illustrated, it will be apparent to one skilled in the art that various changes and modifications in forms and details may be made in these examples without departing from the sprit and scope of the claims and their equivalents. For example, suitable results may be achieved if the described techniques are performed in different order, and/or if components in a described system, architecture, device, or circuit, etc., are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

1. An operation method of a recommender system, the method comprising:
reading an identification code included in access information provided from a recommender, in response to a recommendee accessing a recommendation site based on the provided access information;
collecting activity information about a situation in which the recommendee acts at the recommendation site; and
matching the identification code and the activity information, and storing the matched identification code and activity information in a database.

2. The method of claim 1, wherein the identification code is information that one-to-one matches with the recommender to identify the recommender.

3. The method of claim 1, wherein the activity information includes situations in which the recommendee accesses a website operated by an advertiser and acts at the website, and includes at least one of personal information, visit frequency information, purchase frequency information, purchase amount information, posting creation information, comment creation information, event participation information, posting sharing information, member join information, social networking service (SNS) friend add information, and application download information.

4. The method of claim 1, further comprising:
creating a plurality of identification codes for identifying a plurality of recommenders, respectively;
creating a plurality of pieces of access information that include the plurality of identification codes, respectively; and
providing the plurality of pieces of access information to the plurality of recommenders, respectively.

5. The method of claim 1, further comprising:
statistically processing information stored in the database for each identification code; and
providing a reward to the recommender based on the statistical processing result.

6. A non-transitory computer-readable recording medium storing a program to implement the method according to claim 1.

7. A recommender system comprising:
a processor configured to read an identification code included in access information provided from a recommender, in response to a recommendee accessing a recommendation site based on the provided access information;
a collector configured to collect activity information about a situation in which the recommendee acts at the recommendation site; and
a storage configured to match the identification code and the activity information, and to store the matched identification code and activity information in a database.

8. The recommender system of claim 7, further comprising:
an identification code creator configured to create a plurality of identification codes for identifying a plurality of recommenders, respectively;
an access information creator configured to create a plurality of pieces of access information that include the plurality of identification codes, respectively; and
an access information provider configured to provide the plurality of pieces of access information to the plurality of recommenders, respectively.

9. The recommender system of claim 7, further comprising:
a statistical operator configured to statistically process information stored in the database for each identification code; and
a reward provider configured to provide a reward to the recommender based on the statistical processing result.
